(19) United States
(12) Patent Application Publication
(10) Pub. No.: US 2006/0162254 A1
(43) Pub. Date: Jul. 27, 2006

(54) Sensor device for automatic door assembly

(75) Inventors: Takashi Imai, Otsu-shi (JP); Hirofumi Shimada, Otsu-shi (JP)

Correspondence Address: SUGHRUE MION, PLLC, 2100 PENNSYLVANIA AVENUE, N.W., SUITE 800, WASHINGTON, DC, 20037, US

(73) Assignee: OPTEX CO., LTD.

(21) Appl. No.: 11/334,367

(22) Filed: Jan. 19, 2006

(30) Foreign Application Priority Data
Jan. 21, 2005 (JP) 2005-014369

(51) Int. Cl. E05F 15/02; G08B 13/18; H02P 29/04

(52) U.S. Cl. 49/26; 340/552; 318/364; 49/28

(57) ABSTRACT

To provide a compact sensor device for the automatic door assembly, which can be mounted and dismounted easily to a support member and be effective to secure the safety in the doorway vicinity, a activation sensor (1) for opening a door (3) and a safety sensor (2) for keeping the door (3) open are supported in a fashion overlapped one above the other in a direction conforming to the direction in which they are secured to a support member (5).

### BACKGROUND OF THE INVENTION

1. Field of the Invention

The present invention relates to a sensor device for an automatic door assembly, which is operable to output in response to detection of a human body, an output signal necessary to control selective opening and closure of the automatic door assembly.

2. Description of the Prior Art

It is generally known to use a sensor device such as, for example, a photosensor so that in response to detection of a human body moving past a door assembly, selective opening and closure of the automatic door assembly can be controlled. See, for example, the Japanese Laid-open Patent Publication No. 11-311060. For the photosensor, either an infrared reflection type switch or a pyroelectric switch is generally largely employed.

In the case where the automatic door assembly is installed in the environment in which it tends to be exposed to the weather or airborne dust and dirt, a radar sensor (microwave sensor) operable with microwaves less susceptible to those undesirable or offensive impacts from the atmosphere is generally employed as the sensor device for the automatic door assembly.

It has, however, been found that since the MW (microwave) sensor makes use of, for example, the Doppler effect, the MW sensor is incapable of detecting a still object and, therefore, it is quite often that a person trying to move past the door assembly may be jammed between a sliding door and a pillar or between sliding doors once he or she stands still in the doorway. For this reason, an attempt has been made to use an additional photosensor separate from the MW sensor and disposed below the MW sensor or to use a sensor device having a combined function of the MW sensor and the photosensor, in place of the sole MW sensor, to enable detection of an object in the doorway vicinity.

However, the system in which, in order to secure the safety in the doorway vicinity, the photosensor is employed separately in addition to the MW sensor such as hitherto practiced in the art, has a problem in that since the photosensor is installed using separate support members, the sensor system as a whole tends to become bulky and requires a complicated electric wiring system. Also, replacement of the MW sensor with the sensor device having the combined function of the MW sensor and the photosensor tends to result in increase of the cost.

### SUMMARY OF THE INVENTION

In view of the foregoing, the present invention has been devised to substantially alleviate the foregoing problems and inconveniences inherent in the prior art sensor systems and is intended to provide a sensor device for the automatic door assembly, which is compact and simple and can be mounted and dismounted easily to be a support member, and further can be assembled at a reduced cost and be effective to secure the safety in the doorway vicinity.

In order to accomplish the foregoing object, the present invention provides a sensor device that is supported by a support member through a mounting member and capable of outputting an output signal necessary to control selective opening and closure of the door assembly in response to detection of a human body. This sensor device includes a activation sensor for outputting a activation signal necessary to open the door assembly in response to detection of a human body within a detection area defined for activation purpose and distant from the door assembly, and a safety sensor for outputting a hold signal for outputting a hold signal necessary to keep the door assembly open in response to detection of the human body within a detection area defined for safety purpose and in the vicinity of the door assembly. The activation sensor and the safety sensor are supported in a relation overlapping one above the other in a direction conforming to the fixing direction in which the mounting member is fixed to the support member.

According to the present invention, since the activation sensor and the safety sensor are supported in the relation overlapping one above the other in a direction conforming to the fixing direction in which they are fixed to the mounting member, any existing mounting structure currently employed to support the activation sensor can be employed with the safety sensor mounted over the activation sensor so that the safety in the doorway vicinity can be secured through the safety sensor. Accordingly, mounting and dismounting of the sensor assembly can be effected by a simple one direction operation or movement of the mounting member, and further, the sensor device of the present invention is effective to secure the safety in the doorway vicinity with a compact and simplified structure and at an advantageously reduced cost.

Preferably, the mounting member referred to above is made up of a first mounting piece for fixing the activation sensor to the safety sensor in the overlapped relation and a second mounting piece for fixing the safety sensor to the support member. In this case, since the activation sensor is fixed to the safety sensor through the first mounting piece, which may be an existing mounting piece, and the safety sensor is fixed to the support member through the second mounting piece together with the activation sensor, the first and second mounting pieces can be made compact.

The activation sensor referred to above may preferably include a activation sensor main body and a activation sensor cover and, on the other hand, the safety sensor may include a safety sensor main body having a support projection for supporting the activation sensor main body and a safety sensor cover having an opening defined by an inner peripheral face engageable with an outer peripheral surface of the support projection, with a portion of the safety sensor cover overlapping the activation sensor cover in the direction in which the activation sensor is fixed. These design features are particularly advantageous in that engagement of the opening of the safety sensor cover over the support projection of the safety sensor main body is effective to provide a dust tight effect to the external environment. Also, since the activation sensor cover is fixed to that portion of the safety sensor cover in the overlapped relation, an uncalled-for removal of the safety sensor cover by an unauthorized person can be effectively prevented. That portion of the safety cover may be a seating protuberance formed on the inner peripheral face of the opening in the safety sensor cover.

Also preferably, the activation sensor and the safety sensor may be fixed in an overlapped relation with each other to the support member through a common mounting member. In this case, the activation sensor and the safety sensor can be fixed to the support member through the common mounting member and accordingly, mounting and dismounting of the sensor device of the present invention can be further facilitated.

The activation sensor that can be employed in the practice of the present invention may be a radar sensor operable with microwaves and the safety sensor that can be employed in the practice of the present invention may be an infrared sensor. More preferably, the radar sensor referred to above may be a microwave sensor that makes use of the Doppler effect.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a circuit block diagram showing an automatic door open/closure control device operable with a sensor device for an automatic door assembly according to a first preferred embodiment of the present invention;

FIG. 2 is a schematic side view showing the sensor device for the automatic door assembly according to the first embodiment of the present invention;

FIG. 3A is a front elevational view of the sensor device shown in FIG. 2;

FIG. 3B is a side view of the sensor device;

FIG. 3C is a bottom plan view of the sensor device;

FIG. 4 is a bottom plan view of the sensor device of FIG. 2, showing interior details thereof;

FIG. 5 is an exploded view of the sensor device shown in FIG. 2;

FIG. 6 is a fragmentary side view of the sensor device for the automatic door assembly according to a second preferred embodiment of the present invention, showing a portion thereof; and

FIG. 7 is a front elevational view of that portion of the sensor device shown in FIG. 6.

### DETAILED DESCRIPTION OF THE EMBODIMENTS

Hereinafter, preferred embodiments of the present invention will be described in detail with reference to the accompanying drawings.

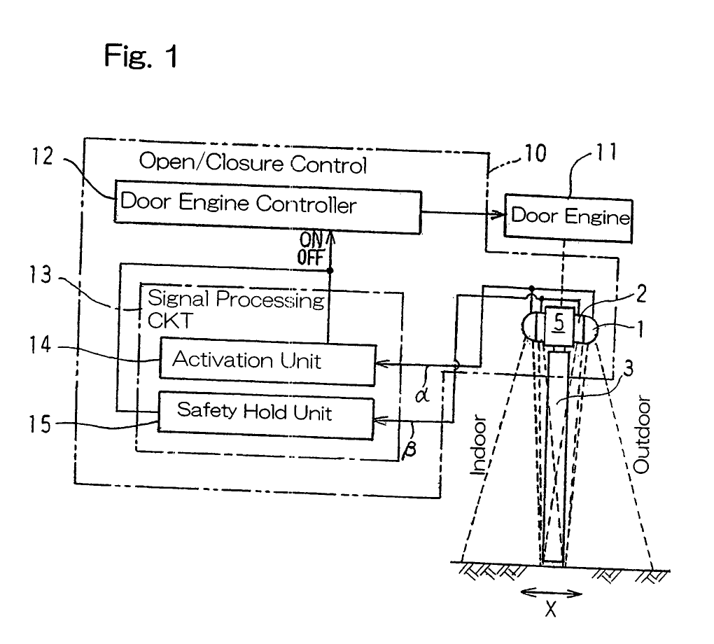

In particular, FIG. 1 illustrates a circuit block diagram of an automatic door open/closure control device that is operable with a sensor device for an automatic door assembly according to a first preferred embodiment of the present invention. As shown therein, the automatic door open/closure control device, generally identified by 10, is designed to control a door engine 11 for driving an automatic sliding door 3 from an open position towards a closed position and also from the closed position towards the open position, i.e., for driving the door assembly to selectively open or close. This open/closure control device 10 includes a door engine controller 12, an automatic door sensor device made up of a activation sensor 1 and a safety sensor 2 both operable to detect the presence or absence of a human body, and a signal processing circuit 13. The signal processing circuit 13 in turn includes a activation unit 14 for outputting a activation signal, which is used to drive the sliding door 3 from the closed position towards the open position, when the activation sensor 1 detects the presence of the human body, and a safety hold unit 15 for outputting a hold signal, which is used to maintain the sliding door 3 in the open position, when the safety sensor 2 detects the presence of the human body. The door engine 11 and the open/close control device 10 are installed inside either the sliding door 3 or a transom 5 used to support an upper wall portion of the sliding door 3.

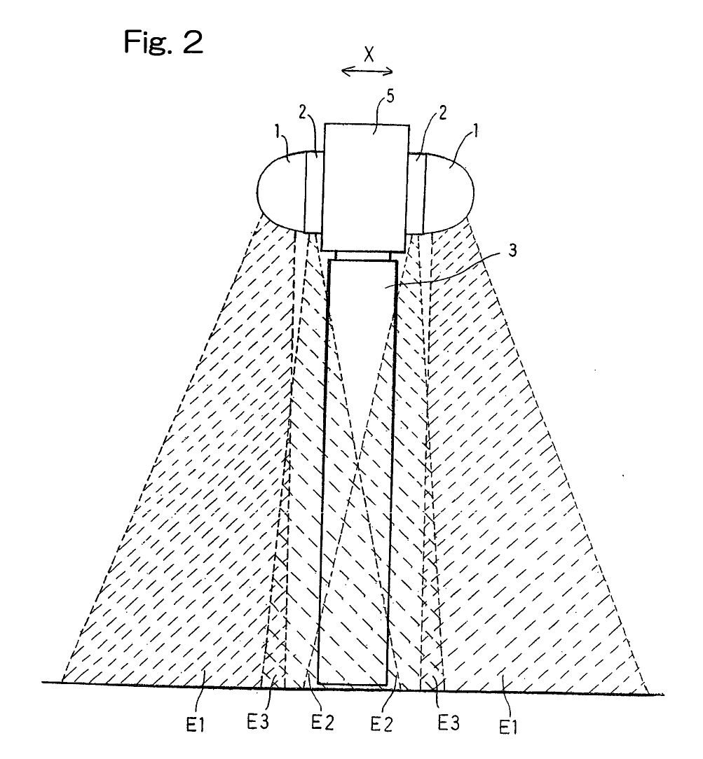

The automatic door sensor device according to the first embodiment of the present invention is shown in a side representation in FIG. 2. As hereinabove described, this automatic door sensor device includes the activation sensor 1 and the safety sensor 2. It is to be noted that in FIG. 2, the automatic door sensor device is shown as employed in two in number, one assigned to detect a person ready to enter a building past the door assembly and the other to detect a person ready to go out of the building past the door assembly. However, since the automatic door sensor devices assigned to detect persons ready to enter and go out of the building past the door assembly, respectively, are of a substantially identical construction and since the present invention in a broad aspect thereof works satisfactorily with the sole automatic door sensor device, reference will be made in this specification to only one of the automatic door sensor devices.

The activation sensor 1 referred to above and forming a part of the automatic door sensor device is supported by an outer face of a transom 5 above the automatic sliding door 3 and is operable to output a detected human body signal a in the event that the activation sensor 1 detects the presence of a human body within a activation detection area El distant from the sliding door 3. On the other hand, the safety sensor 2 referred to above and forming another part of the automatic door sensor device is supported on the outer face of the transom 5 above the sliding door 3 and is operable to output a detected human body signal β in the event that the safety sensor 2 detects the presence of a human body (a still object) within a safety detection area E2 defined in the vicinity of the sliding door 3, for example, in a portion of the doorway adjacent the path of movement of the sliding door 3. The activation detection area E1 covered by the activation sensor 1 and the safety detection area E2 covered by the safety sensor 2 overlap partly in a region near the sliding door 3 as indicated by E3. Specifically, the activation sensor 1 and the safety sensor 2, both provided in the illustrated embodiment, are employed in the form of a MW (microwave) sensor utilizing the Doppler effect and an AIR (active type infrared) sensor, respectively.

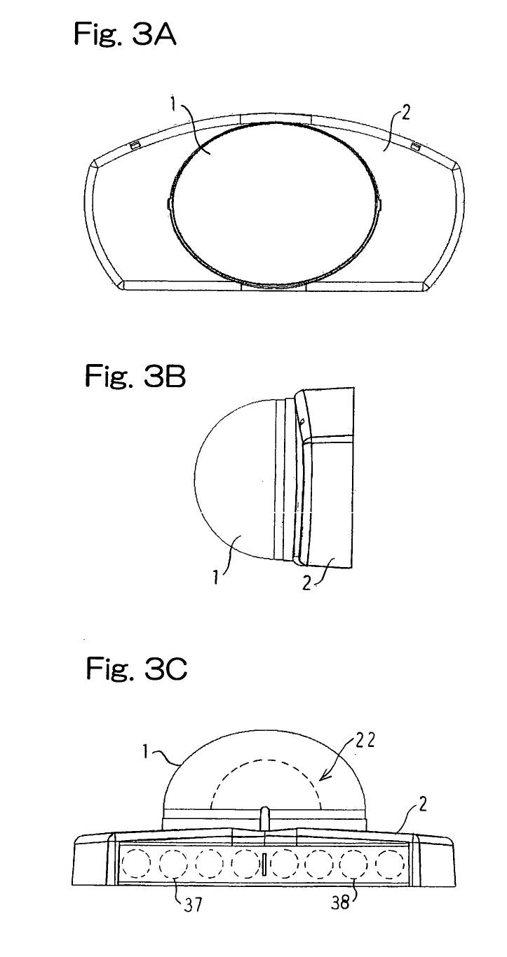

As shown in FIGS. 3A to 3C, the activation sensor 1, or the MW sensor, is of a generally hemispherical configuration in a side view having its base representing a substantially oval shape in a front view, whereas the safety sensor 2, or the AIR sensor, is of a generally flattened configuration. In the illustrated embodiment, as best shown in a front elevational view in FIG. 3A, the MW sensor 1 has its base smaller in size than that of the AIR sensor 2 when viewed from front, with the MW sensor 1 positioned substantially at a geometric center area of the AIR sensor 2, and as best shown in a side representation in FIG. 3B, the MW sensor 1 is mounted on the AIR sensor 2 with a flat base area of the MW sensor 1 held in abutment with a flat bottom surface of the AIR sensor 2. Also as best shown in a bottom plan view in FIG. 3C, the MW sensor 1 is provided with an MW sensor main body 22 for emitting and receiving microwaves and, on the other hand, the AIR sensor 2 is provided with a plurality of, for example, four, beam projecting elements 37 for projecting light downwardly and a plurality of, for example, four, beam receiving elements 38 for receiving light reflected from below.

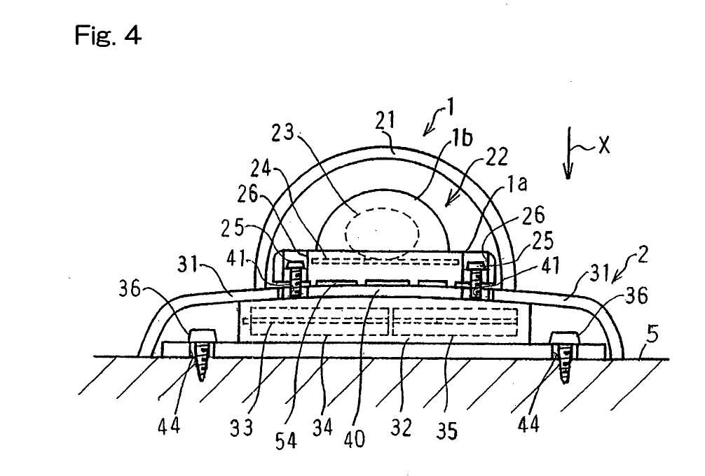

FIG. 4 illustrates a bottom plan view of the automatic door sensor device, showing interior details thereof. The MW sensor 1, which may be any existing MW sensor, includes a generally hemispherical MW sensor cover 21 covering the MW sensor main body 22, the MW sensor main body 22 includes a base support 1a of a substantially oval shape when viewed from front and a hemispherical MW sensor element 1b supported on the base support 1a. A sensor module 23 is disposed inside the hemispherical MW sensor element 1b, and an electric circuit substrate 24 is disposed inside the base support 1a. The base support 1a has screw insertion throughholes 26 defined therein for passage therethrough of corresponding first mounting pieces (male screw) 25 that are used to secure the base support 1a to a support member (a transom) 5. The screw insertion throughholes 26 defined in the base support 1a extends in a direction conforming to the fixing direction X in which the sensor device is secured to the transom 5.

The AIR sensor 2 includes an AIR sensor main body 32, which is in turn made up of an electric power supply circuit substrate 33, a beam projecting circuit substrate 34 and a beam receiving circuit substrate 35. The beam projecting elements 37 and the beam receiving elements 38, both referred to above, are arranged forwardly (or downwardly as viewed in FIG. 2) of those circuit substrates 34, 35 so as to be oriented towards the doorway surface, with respective lens elements (not shown) positioned forwardly of those beam projecting and receiving elements 37 and 38.

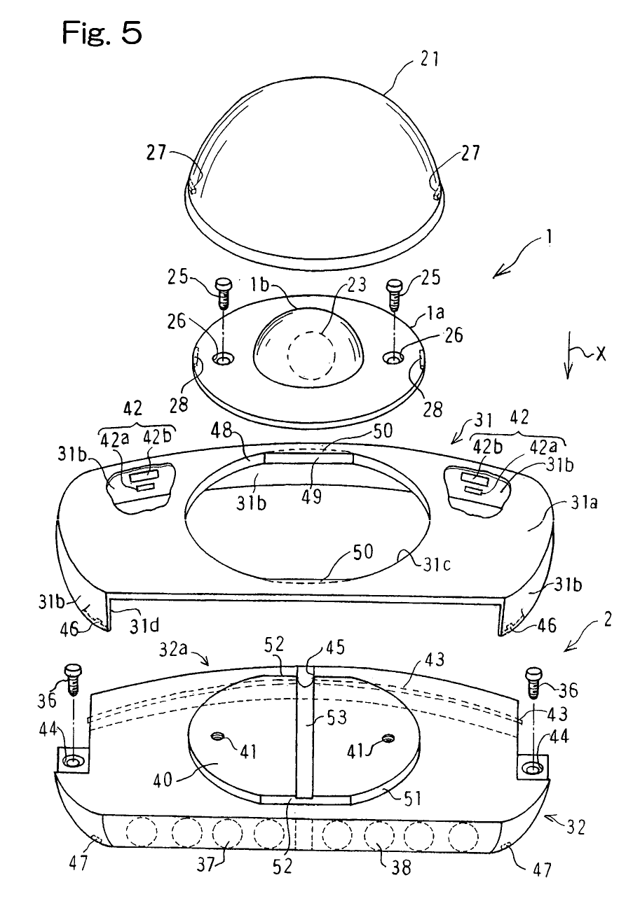

As best shown in FIG. 5, the AIR sensor main body 32 has a substantially oval projection 40, defined at a substantially center area thereof and having a substantially oval outer peripheral surface 51, and also has internally threaded screw holes 41 defined therein at respective locations alignable with the screw insertion throughholes 26 that is defined in the MW sensor 1 as described hereinabove. The internally threaded screw holes 41 defined in the AIR sensor main body 32 extend in a direction conforming to the fixing direction X and, accordingly, when the MW sensor 1 is overlapped on the AIR sensor 2, the screw insertion throughholes 26 in the MW sensor 1 can be aligned with the internally threaded screw holes 41 in the AIR sensor 2. Therefore, after respective male screws 25 have been inserted through the screw insertion throughholes 26 and then threaded into the internally threaded screw holes 41 in the AIR sensor 2, the MW sensor 1 and the AIR sensor 2 are fastened together in an overlapping relation with each other.

The AIR sensor 2 also has screw insertion holes 44 defined therein so as to extend in a direction conforming to the fixing direction X, so that when corresponding second mounting pieces (tapping screws or male screws) 36 inserted through the screw insertion holes 44 are threaded in the transom 5 or threaded into associated internally threaded screw holes (not shown) defined in the transom 5, the AIR sensor 2 can be firmly secured to the transom 5. Thus, it will readily be seen that the assembly of the MW sensor 1 and the AIR sensor 2 held in the overlapped relation with each other in the manner described above by means of the screws 25 can be firmly fixed to the transom 5 in the fixing direction X by means of the second mounting pieces 36.

The sensor device of the foregoing embodiment are shown as exploded in FIG. 5. The MW sensor cover 21 has a plurality of, for example, two, engagement projections 27 and 27 defined inside thereof and engageable with corresponding notches 28 and 28 defined in a bottom portion of the MW sensor main body 22, so that the MW sensor cover 21 can be combined or fixed together with the MW sensor main body 22 when the engagement projections 27 and 27 are engaged in the corresponding notches 28 and 28. The MW sensor main body 22 also has a ditch 54 defined in a bottom surface thereof for drainage of water as best shown in FIG. 4.

On the other hand, the AIR sensor 2 includes an AIR sensor cover 31 covering the AIR sensor main body 32. The AIR sensor cover 31 is made up of a major wall 31a and a side wall 31b lying generally perpendicular to the major wall 31a and having a front portion thereof depleted to define a light projecting and receiving window 31d through which the AIR sensor main body 32, i.e., the beam projecting and receiving elements 37 and 38, is exposed to the outside of the AIR sensor cover 31. The major wall 31a of the AIR sensor cover 31 has a substantially oval opening 31c defined at a geometric center area thereof in correspondence with the support base 1a of the MW sensor main body 22. The substantially oval projection 40 of the AIR sensor main body 32 has the screw holes 44 for receiving therein the respective second mounting pieces 36.

An inner peripheral face 48 of the substantially oval opening 31c defined in the AIR sensor cover 31 lies parallel to the fixing direction X and has its opposite portions protruding inwardly of the oval opening 31c to define respective seating protuberances 50 and 50. In other words, the AIR sensor cover 31 has the seating protuberances 50 and 50 defined therein so as to protrude from corresponding opposite portions of the inner peripheral face 48 of the oval opening 31 in a direction inwardly of the oval opening 31, so that an oval bottom of the MW sensor cover 21 can be seated on those seating protuberances 50 and 50 when the MW sensor cover 21 is capped onto the AIR sensor cover 31. With this structure a portion or the protuberances 50 of the AIR sensor cover 31 is overlapped with the MW sensor cover 21. The seating protuberances 50 and 50 so formed in the major wall 31a of the AIR sensor cover 31 are of a substantially crescent shape having respective flat faces 49 and 49, which when the

AIR sensor cover 31 is capped onto the AIR sensor main body 32 with the oval projection 40 received inside the oval opening 31c, the flat faces 49 and 49 of the respective seating protuberances 50 and 50 can be held substantially in contact with corresponding cut faces 52 and 52 formed in the outer peripheral surface 51 of the oval projection 40.

The AIR sensor main body 32 also has a wiring hole 45, a ditch 53 and another ditch not shown, but defined in a bottom surface thereof.

As hereinabove described, since the inner peripheral face 48 of the substantially oval opening 31c defined in the AIR sensor cover 31 (inclusive of the flat faces 49 and 49 of the crescent shaped seating protuberances 50 and 50) engages the outer peripheral surface of the oval projection 40 (inclusive of the cut faces 52 and 52) of the AIR sensor main body 32 for supporting the MW sensor main body 22, the dust tight effect to the external environment can be obtained. Also, since the MW sensor cover 21 is, when capped into the oval opening 31c in the AIR sensor cover 31, held in abutment with the seating protuberances 50 and 50 (forming respective parts of the AIR sensor cover 31), the AIR sensor cover 31 cannot be removed unless the MW 20 sensor cover 21 is removed and, accordingly, an uncalled-for removal of the AIR sensor cover 31 by an unauthorized person can be effectively prevented.

The AIR sensor cover 31 has engagement sections 42 and 42 defined in an inner face of the side wall 31b thereof, which engagement sections 42 and 42 are engageable with a rib 43 that is defined in a rear surface area 32a of the AIR sensor main body 32 so as to extend in a direction lengthwise of the AIR sensor main body 32. Each engagement section 42 includes protrusions 42a and 42b which nip the rib 43 of the AIR sensor main body 32. The side wall 31b of the AIR sensor cover 31 has its bottom edge portion formed with engagement pawls 46 and 46 positioned inside the side wall 31b, which pawls 46 and 46 are engageable with corresponding cutouts 47 and 47, defined in a bottom region of the AIR sensor main body 32, to thereby retain the AIR sensor cover 31 in a condition fixed to the AIR sensor main body 32.

Hereinafter, the manner in which the MW sensor 1 and the AIR sensor 2 are secured to the transom 5 will be described in detail with particular reference to FIG. 5. At the outset, the AIR sensor main body 32 is rigidly secured to the transom 5 with the male second mounting pieces (or the tapping screws) 36 threaded into the transom 5 through the insertion holes 44. After the AIR sensor main body 32 has been so secured to the transom 5 in the manner described above, the AIR sensor cover 31 is capped onto the AIR sensor main body 32 with the rib 43 in the rear surface area 32a of the AIR sensor main body 32 engaged in the engagement sections 42 and 42 in the inner face of the side wall 31b of the AIR sensor cover 31 and, at the same time, with the engagement pawls 46 and 46 engaged in the corresponding cutouts 47 and 47, to thereby allow the AIR sensor cover 31 to be held in a condition fixed to the AIR sensor main body 32.

Following the mounting of the AIR sensor 2 on the transom 5 in the manner described above, the MW sensor main body 22 is mounted on the AIR sensor main body 32 with the first mounting pieces or the male screws 25 firmly threaded into the internally threaded screw holes 41 in the AIR sensor main body 32 through the screw insertion throughholes 26 in the AIR sensor 2. In this condition, the oval base support 1a of the MW sensor main body 22 is immovably seated within the oval opening 31c in the AIR sensor cover 31 with the hemispherical MW sensor element 1b oriented in a direction counter to the AIR sensor main body 32. Finally, the MW sensor cover 21 is capped onto the MW sensor main body 22 with the engagement projections 27 and 27 engaged in corresponding notches 28 and 28 defined in that bottom portion of the MW sensor main body 22. In this way, assemblage of the sensor device of the present invention completes. An electric wiring system for the electrical connection of the AIR sensor 2 with an external electric control circuit, for example, the automatic door open/closure control device 10 shown in FIG. 1, is accomplished by the utilization of a known wiring path used to connect the existing MW sensor 1 with the external electric control circuit.

According to the present invention, as hereinabove described, the sensor device is so designed that the MW sensor 1 and the AIR sensor 2 are supported to the transom 5 or any other suitable support member by the utilization of the mounting holes and pieces employed in association with the existing MW sensor 1 and also by the utilization of the site of installation of the existing MW sensor 1 and the electric wiring system used to connect the MW sensor 1 with the external electric control circuit. Accordingly, the present invention is featured in that the activation or MW sensor 1 and the safety or AIR sensor 2 are advantageously integrated together in a compact construction.

It is to be noted that the MW sensor 1 and the AIR sensor 2 employed in the practice of the present invention are functionally separate from each other and, hence, can work independently of each other. Accordingly, if so desired, the MW sensor 1 and the AIR sensor 2 may be secured to the transom 5 separately in a juxtaposed fashion.

Referring again to FIG. 1, when the activation sensor 1 detects the presence of a human body in the activation detection area E1 distant from and defined in, for example, an outdoor area, the activation sensor 1 provides the activation unit 14 of the signal processing circuit 13 with a detected human body signal α. In response to this detected human body signal a, the activation unit 14 outputs an ON signal, indicative of opening of the door assembly, to the door engine 11 through the door engine controller 12, with the sliding door 3 consequently moved from the closed position towards the open position.

In the meantime, if no safety sensor such as identified by 2 is employed, a person attempting to move through the doorway after having passed the activation detection area E1 (FIG. 2) will be jammed in the doorway when he or she abruptly stands still in that portion of the doorway adjacent the path of movement of the sliding door 3. Specifically, since the activation sensor 1 no longer outputs the detected human body signal a to the activation unit 14 and, hence, no ON signal is supplied therefrom to the door engine 11 through the door controller 12. Instead, after a predetermined length of time subsequent to the cease of the ON signal from the activation unit 14 resulting from interruption of supply of the detected human body signal a from the activation sensor 1 to the activation unit 14, the signal processing circuit 13 generates an OFF signal, indicative of closure of the door assembly, to door engine 11 through the door engine controller 12, with the sliding door 3 consequently moved from the open position towards the closed position.

The foregoing inconvenience may equally occur even when the activation detection area E1 is expanded to cover that portion of the doorway adjacent the path of movement of the sliding door 3 because the MW sensor 1 utilizing the Doppler effect is incapable of detecting a still object such as a still person standing still in that portion of the doorway adjacent the path of movement of the sliding door 3.

However, the present invention makes use of the AIR sensor 2 in combination with the MW sensor 1. Specifically, while the MW sensor 1 is incapable of detecting the person standing still as hereinabove discussed, the AIR sensor 2 detects the presence of the still object and, hence, the person standing still within the safety detection area E2. Therefore, the human body will not be jammed between the sliding door 3 and a pillar, once he or she stands still in the doorway, without the sliding door 3 being moved to the closed position in that occasion. The use of the MW sensor 1 in combination with the AIR sensor 2 is thus effective to secure the safety in the vicinity of the sliding door 3.

As hereinbefore fully described, the present invention represented by the foregoing embodiment is effective to secure the safety in the doorway vicinity with a compact and simplified structure and at an advantageously reduced cost since the activation sensor 1 and the safety sensor 2 are supported by the transom 5 in an overlapped fashion one above the other in a direction conforming to the fixing direction X. Furthermore, mounting and dismounting of the both sensors 1 and 2 can be effected by a simple one direction operation or movement of the mounting pieces 25 and 36 thereby facilitating operator's work of mounting and dismounting.

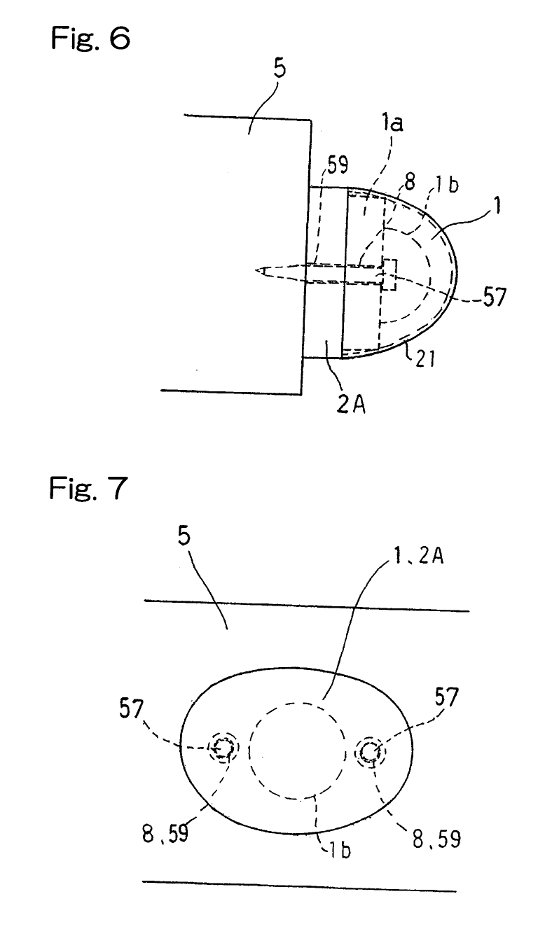

Hereinafter, a second preferred embodiment of the present invention will be described with particular reference to FIGS. 6 and 7. It is, however, to be noted that the second embodiment is similar to the first embodiment, but differs therefrom in respect of the shape and mounting structure of the AIR sensor 2.

Referring now to FIG. 6, showing a side view of the sensor device, as is the case with those in the previously described embodiment, the MW sensor 1 is of a generally hemispherical configuration having its base representing a substantially oval shape when viewed from front and the AIR sensor 2A is of a generally flattened configuration. However, in the second embodiment, as best shown in a front elevational view in FIG. 7, the AIR sensor 2A is of a size substantially identical with that of the MW sensor 1 when viewed from front and, hence, the AIR sensor 2 has an outer periphery held in flush with that of the base of the MW sensor 1.

The existing MW sensor 1 is of a structure in which the base support la thereof has screw insertion throughholes 8 defined therein for the passage of mounting pieces (screw members) used to secure the MW sensor 1 to the transom 5. In correspondence therewith, the AIR sensor 2A has corresponding screw insertion throughholes 59 defined therein at respective locations alignable with the screw insertion throughholes 8 in the MW sensor 1 when the AIR sensor 2A is mounted onto the MW sensor 1 as shown in FIG. 6. The MW sensor 1 and the AIR sensor 2A are, after the base support la of the MW sensor 1 and the AIR sensor 2 have been overlapped one above the other, secured rigidly to the transom 5 by means of common mounting pieces (tapping screws) 57 and 57 that are passed through the screw insertion throughholes 8 and then through the screw insertion throughholes 59 and firmly threaded in the transom 5 or any other suitable support member for securement of the existing MW sensor 1 to the transom 5 or any other suitable support member, and finally, the MW sensor cover 21 attached to the base support 1a. In other words, by the utilization of the site of installation of the existing MW sensor 1 and the electric wiring system used to connect the MW sensor 1 with the external electric control circuit, the AIR sensor 2A is positioned having been sandwiched between the MW sensor 1 and the transom 5. Accordingly, the sensor device of the present invention is compactized with the MW sensor 1 and the AIR sensor 2 integrated together.

As shown in a front elevational view in FIG. 7, the base of the MW sensor 1 and the outer periphery of the AIR sensor 2A have substantially identical outer contours and, accordingly, when the MW sensor 1 and the AIR sensor 2A are integrated together in the overlapped fashion, the resultant sensor device gives rise to a smoothly contoured shape that is feasible to render the sensor device to provide an appealing appearance.

As hereinbefore fully described, the present invention represented by the previously described second embodiment is effective to secure the safety in the doorway vicinity with a compact and simplified structure having a smoothly contoured shape and at an advantageously reduced cost since the activation sensor 1 and the safety sensor 2A are rigidly secured to the transom 5 in an overlapped fashion one above the other and since the safety sensor 2A is mounted on the activation sensor 1 by the utilization of a mounting structure of any existing activation sensor 1 to secure the safety in the doorway vicinity.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. For example, although in any one of the foregoing embodiments of the present invention, the activation sensor 1 has been described as employed in the form of a MW sensor utilizing the Doppler effect and the safety sensor 2 or 2A has been described as employed in the form of an AIR (active type infrared) sensor, they may not be always limited thereto and a combination of any other activation sensor with any other safety sensor can be employed, provided that the resultant sensor device can be effective to secure the safety in the doorway vicinity. By way of example, a MW sensor that does not make use of the Doppler effect, a PIR (passive type infrared) sensor, an ultrasonic sensor, an electric wave type sensor or an image processing device can be employed.

Accordingly, such changes and modifications are, unless they depart from the scope of the present invention as delivered from the claims annexed hereto, to be construed as included therein.

What is claimed is:

1. A sensor device for a door assembly, which is supported by a support member through a mounting member and capable of outputting an output signal necessary to control selective opening and closure of the door assembly in response to detection of a human body, which device comprises:
a activation sensor for outputting a activation signal necessary to open the door assembly in response to detection of a human body within a detection area defined for activation purpose and distant from the door assembly; and
a safety sensor for outputting a hold signal necessary to keep the door assembly open in response to detection of the human body within a detection area defined for safety purpose and in the vicinity of the door assembly;
wherein the activation sensor and the safety sensor are supported in a relation overlapping one above the other in a direction conforming to the fixing direction in which the mounting member is fixed to the support member.

2. The sensor device for the automatic door assembly as claimed in claim 1, wherein the mounting member comprises a first mounting piece for fixing the activation sensor to the safety sensor in the overlapped relation and a second mounting piece for fixing the safety sensor to the support member.

3. The sensor device for the automatic door assembly as claimed in claim 2, wherein the activation sensor includes a activation sensor main body and a activation sensor cover, and the safety sensor includes a safety sensor main body having a support projection for supporting the activation sensor main body and a safety sensor cover having an opening defined by an inner peripheral face engageable with an outer peripheral surface of the support projection, with a portion of the safety sensor cover overlapping the activation sensor cover in the fixing direction in which the activation sensor is fixed.

4. The sensor device for the automatic door assembly as claimed in claim 3, said portion of the safety sensor cover comprises a seating protuberance formed on the inner peripheral face of the opening in the safety sensor cover.

5. The sensor device for the automatic door assembly as claimed in claim 1, wherein the activation sensor and the safety sensor are fixed in an overlapped relation with each other to the support member through a common mounting member.

6. The sensor device for the automatic door assembly as claimed in claims 1, wherein the activation sensor is a radar sensor operable with microwaves and the safety sensor is an infrared sensor.

7. The sensor device for the automatic door assembly as claimed in claim 6, wherein the radar sensor is a microwave sensor that makes use of the Doppler effect.

8. The sensor device for the automatic door assembly as claimed in claim 1, wherein the mounting member comprises a screw member.
